(19) United States
(12) Patent Application Publication
(10) Pub. No.: US 2017/0173562 A1
(43) Pub. Date: Jun. 22, 2017

(54) FUNCTIONALIZED POROUS CARBON, METHODS FOR MAKING SAME, AND METHODS FOR USING SAME TO REMOVE CONTAMINANTS FROM A FLUID

(71) Applicant: AZ ELECTRONIC MATERIALS (LUXEMBOURG) S.A.R.L., SOMERVILLE, NJ (US)

(72) Inventors: Ayrat Dimiev, Basking Ridge, NJ (US); Pui Lam Chiu, Chatham, NJ (US)

(73) Assignee: AZ ELECTRONIC MATERIALS (LUXEMBOURG) S.A.R.L., Luxembourg (LU)

(21) Appl. No.: 14/978,462

(22) Filed: Dec. 22, 2015

(51) Int. Cl. B01J 20/30; B01J 20/22; C02F 1/28; C01B 31/02

(52) U.S. Cl. CPC B01J 20/3085; C01B 31/02; B01J 20/22; C02F 1/283; C01P 2006/12; C01P 2004/03; C01P 2006/14; C01P 2002/88; C01P 2002/85; C02F 2101/006

(57) ABSTRACT

The present invention relates to materials comprising a functionalized porous carbon, methods of forming a functionalized porous carbon, and methods of treating fluids with a functionalized porous carbon.

### FIELD OF INVENTION

Methods and materials useful for the treatment of water, waste water, sewage and other fluids by sorption and, in particular, to a functionalized porous carbon, methods for making same, and methods for using same to remove contaminants from a fluid.

### BACKGROUND

Current methods of removing radionuclides and metals from water include sorption of the contaminants by three different types of materials: a) naturally occurring porous materials, such as clays and zeolites; b) ion-exchange resins, and c) carbon-based materials such as graphene oxide and oxidatively modified coke.

The sorption effectiveness of rocky porous materials such as clays or zeolites (e.g. U.S. Pat. Nos. 4,087,374 and 6,531,064) is low, despite their high porosity. Moreover, after absorption, the contaminated clays and zeolites with absorbed radionuclides need to be properly stored. Containment of contaminated absorbent is an additional problem to be solved.

The ion-exchange resins (U.S. Pat. No. 3,340,200) require structural support. Such requirement for structural support increases the costs and limits the effective surface areas of the ion-exchange resins.

Charcoal, activated charcoal and activated carbon all have very high surface areas. These carbon materials are effectively used for sorption of gaseous contaminants such as SOx and NOx from gaseous phase (U.S. Pat. No. 5,270,279). They are also used to remove organic contaminants from liquid aqueous phase. However, the effectiveness of such carbon materials towards removing metals from water sources is not very high. Consequently, activated carbon is not typically used for this purpose.

Recently, a method of sorption of radionuclides by graphene oxide (GO) was demonstrated (Romanchuk et al., Phys. Chem. Phys. 2013, 15, 2321-2327 DOI: 10.1039/c2cp44593j and PCT/US2012/026766). Despite its effectiveness in removing radionuclides, GO has several limitations. A first limitation is the cost of preparing high purity GO. A second limitation of using GO is the difficulty of the purification procedures. Separation of contaminated GO from wash-water is a difficult task due to high stability of GO colloid solutions and due to the GO's pore blocking ability. As an alternative strategy, GO can be assembled on solid support materials. However, the engineering of such structures can be costly and impractical.

Recently, a new method of sorption of radionuclides by oxidatively modified carbon (OMC) was demonstrated (WO 2014179670 A1 20141106). This method has certain advantages over GO, such as lower production cost and lower operation/purification cost due to the 3D granular nature of OMC. However, water purification effectiveness of OMC is not high enough.

Recently, a new method of preparing porous carbon (CA 2860615 A1 20140704) by baking asphaltenes with potassium hydroxide was demonstrated. The as-made porous carbon was aimed for carbon dioxide sorption. Further oxidation of as-made porous carbon and its use in any applications other than carbon dioxide sorption was not envisioned.

Current methods of removing radioactive elements and metals from water have numerous limitations in terms of cost, efficiency and versatility. Therefore, new methods and materials are required to effectively capture metal cations from water sources. In particular, it would be advantageous to provide methods and materials that are more efficient than the known methods for removing contaminants from a fluid. Further, it would be advantageous to provide methods and materials that are useful for removing contaminants from a fluid wherein the need for additional support structures is eliminated. It would also be advantageous for the materials and methods to be able to be practiced using traditional absorption columns or by dispersing the materials within the fluid. In addition, it would be extraordinarily advantageous if the materials and methods provide for easy and/or efficient disposal of the contaminated sorbents. The present disclosure addresses this need.

### SUMMARY OF THE INVENTION

In one of its aspects, the present invention relates to a material comprising a functionalized porous carbon, wherein the functionalized porous carbon has an average surface area above 300 m²/g. In some embodiments, the functionalized porous carbon has an average pore diameter ranging from 5 μm to 0.1 nm. In some embodiments, the functionalized porous carbon has an average particle diameter ranging from 5 μm through 3 mm. In some embodiments, the functionalized porous carbon has an average surface area ranging from 400 m²/g. to 4000 m²/g. In some embodiments, the functionalized porous carbon comprises oxygen-containing functional groups. In some embodiments, the oxygen-containing functional groups comprises carboxylic groups.

In another of its aspects, the present invention relates to a method of forming a functionalized porous carbon comprising the step of treating a porous carbon having an average surface area above 300 m²/g with an oxidizer. In some embodiments, the method further comprises the step of treating a carbon source with one or more etchants, activated agents and/or pore generating agents at high temperature to form the porous carbon. In some embodiments, the method further comprises the step of treating a carbon source with KOH, NaOH, LiOH or the like at high temperature to form the porous carbon. In some embodiments, the carbon source is obtained from a source comprising asphaltene, biochar, and combinations thereof. In some embodiments, the carbon source comprises asphaltene. In some embodiments, the carbon source comprises asphalt. In some embodiments, the carbon source comprises gilsonite. In some embodiments, the oxidizer contains KMnO₄. In some embodiments, the oxidizer contains HNO₃. In some embodiments, the oxidizer contains K₂Cr₂O₇.

In yet another of its aspects, the present invention relates to a method of treating a fluid comprising a contaminant, the method comprising the step of contacting the fluid with a functionalized porous carbon under conditions that lead to sorption of the contaminant by the functionalized porous carbon. In some embodiments, the contaminant comprises radionuclides, metals and combinations thereof. In some embodiments, the radionuclides are selected from the group consisting of Sr, Cs, U, Ac, Eu and combinations thereof. In some embodiments, the metals are selected from the group consisting of heavy metals, light metals, metal cations, metal halides, metal sulfates, metal hydroxides, mixed metal cations, and combinations thereof. In some embodiments, the fluid is water.

### BRIEF DESCRIPTION OF THE DRAWINGS

FIG. 1 shows scanning electron microscopy (SEM) images of the FPC of Example 4.

FIG. 2 provides the pore volume distribution for KMnO₄-FPC of Example 4 and the unfunctionalized porous carbon.

FIG. 3 provides thermogravimetric analysis (TGA) data of the FPC of Examples 4 and 5 in comparison to the porous carbon.

FIG. 4 shows the C1s XPS spectra for the FPC of Example 4 in comparison to that for the porous carbon.

FIG. 5 provides comparative data for sorption of the FPC of Examples 4 and 5, and that for GO, OMC and the unfunctionalized porous carbon.

FIG. 6 is the sorption isotherm for the FPC of Example 5 (HNO₃-FPC sample).

FIG. 7 is a comparison of the sorption effectiveness of KMnO₄-FPC (Example 4) with that for OMC.

FIG. 8 is a comparison of the sorption effectiveness of HNO₃-FPC (Example 5) with that for KMnO₄-FPC (Example 4).

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms such as “includes” and “included”, is not limiting. Also, terms such as “element” or “component” encompass both elements or components comprising one unit and elements or components that comprise more than one unit, unless specifically stated otherwise. As used herein, the conjunction “and” is intended to be inclusive and the conjunction “or” is not intended to be exclusive unless otherwise indicated. For example, the phrase “or, alternatively” is intended to be exclusive. As used herein, the term “and/or” refers to any combination of the foregoing elements including using a single element.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

The present invention relates to a functionalized porous carbon (FPC). In some embodiments, the functionalized porous carbon has an average pore diameter ranging from 5 μm to 0.1 nm. In some embodiments, the functionalized porous carbon has an average surface area ranging from 100 m²/g to 4000 m²/g. In some embodiments, the functionalized porous carbon has an average particle size ranging from 10 nm to 5 mm. In some embodiments, the functionalized porous carbon comprises oxygen-containing functional groups and, in particular, carboxylic groups. In some embodiments, the functionalized porous carbon has a three-dimensional structure. In some embodiments, the functionalized porous carbon is in the form of particles.

In addition, the present invention relates to methods of making a functionalized porous carbon (FPC). In some embodiments, the functionalized porous carbon is prepared by forming a porous carbon from a carbon source and oxidizing the porous carbon to form the functionalized porous carbon.

The present invention also relates to methods of treating fluids and, in particular, to methods of treating a fluid to remove one or more contaminants by contacting the fluid with a functionalized porous carbon under conditions that lead to sorption of the contaminants by the functionalized porous carbon. In some embodiments, the method further comprises a step of separating the functionalized porous carbon from the fluid after contaminants are sorbed by the functionalized porous carbon.

Further, the present invention relates to apparatuses comprising functionalized porous carbon and, in particular, to apparatuses comprising functionalized porous carbon that are useful for capturing contaminants from a fluid. In some embodiments, the apparatuses comprise a porous container for containing the functionalized porous carbon such that the fluid passes through the porous container and contacts the functionalized porous carbon. In some embodiments, the porous container has flexible walls, and can resemble a sack-like structure. In some embodiments, the apparatuses comprise a housing for housing the functionalized porous carbon such that the fluid flows through the housing and contacts the functionalized porous carbon. In some embodiments, the housing is a column or a filter. In some embodiments, a cross-flow filtration system is used to capture contaminants from the fluid, where the functionalized porous carbon remains inside the cross-flow filtering system with captured contaminants (e.g., metals and radionuclides) while the treated fluid passes through the cross-flow filtering system.

The functionalized porous carbons of the present disclosure may have various types of structures. For instance, in some embodiments, the functionalized porous carbons have a three-dimensional structure. In some embodiments, the functionalized porous carbons have a granular structure. In some embodiments, the functionalized porous carbon has a powdery structure.

In some embodiments, the functionalized porous carbon of the present disclosure has an average surface area above about 300 m²/g. In some embodiments, the functionalized porous carbon of the present disclosure has an average surface area above about 600 m²/g. In some embodiments, the functionalized porous carbon of the present disclosure has an average surface area above about 1500 m²/g. In some embodiments, the functionalized porous carbon of the present disclosure has an average surface area ranging from about 300 m²/g to about 4000 m²/g. In some embodiments, the functionalized porous carbon of the present disclosure has an average surface area ranging from about 300 m²/g to about 1600 m²/g. In some embodiments, the functionalized porous carbon of the present disclosure has an average surface area ranging from about 300 m²/g to about 600 m²/g. In some embodiments, the functionalized porous carbon of the present disclosure has an average surface area ranging from about 400 m²/g to about 1100 m²/g.

In some embodiments, the functionalized porous carbons of the present disclosure have a porous structure. In some embodiments, the functionalized porous carbons have a plurality of pores. In some embodiments, the functionalized porous carbon has an average pore diameter ranging from about 5 μm to about 0.1 nm, from about 1 μm to about 0.1 nm, or from about 0.5 μm to about 0.3 nm.

In some embodiments, the functionalized porous carbon of the present disclosure is in the form of particles. In some embodiments, the functionalized porous carbon has an average particles diameter ranging from about 5 μm through 3 mm. In some embodiments, the functionalized porous carbon has an average particle diameter ranging from about 50 μm to about 3 mm. In some embodiments, the particles have diameters ranging from about 100 μm to about 3 mm.

The functionalized porous carbon can be prepared in a process comprising the steps of preparing a porous carbon from a carbon source and oxidizing the porous carbon to form a functionalized porous carbon.

In some embodiments, the porous carbon is prepared by treating a carbon source with one or more etchants, activated agents and/or pore generating agents at high temperature. In some embodiments, the porous carbon is prepared by baking the carbon source in the presence of one or more etchants, activated agents and/or pore generating agents. In some embodiments, the porous carbon is prepared by baking the carbon source at high temperature. In some embodiments, the porous carbon is prepared by baking the carbon source with KOH at high temperature. In some embodiments, the porous carbon is prepared by baking the carbon source with NaOH at high temperature. In some embodiments, the porous carbon is prepared by baking the carbon source with LiOH at high temperature. In some embodiments, the porous carbon is heated at a temperature ranging between 600° C. and 800° C. In some embodiments, the carbon source comprises asphaltenes, coal, bituminous coal, charcoal, biochar, and combination of thereof. In some embodiments, the carbon source comprises asphaltenes. In some embodiments, the carbon source comprises asphalts. In some embodiments, the carbon source comprises gilsonite.

In some embodiments, the as-prepared porous carbon is oxidized to obtain the functionalized porous carbon. In some embodiments, the oxidation step includes exposing the porous carbon to an oxidative acidic media. The oxidative acidic media comprises an acidic media and an oxidant dissolved in the acidic media.

As described in detail below, various carbon sources can be used to prepare porous carbon; various porous carbons can be used for the oxidation step; and various oxidants and oxidizing methods may be utilized to prepare functionalized porous carbons.

In one particular embodiment, untreated gilsonite is mixed with KOH, NaOH, LiOH or the like in a blender or a roller. The weight ratio of KOH, NaOH, LiOH or the like to untreated gilsonite can be varied. For example, a weight ratio of KOH, NaOH, LiOH or the like to untreated gilsonite ranging from 4 to 2 can be used. The mixture is loaded into a furnace and preferably purged under nitrogen atmosphere. The duration of the purge can be varied. For example, the duration of the purge can be about 30 minutes. The mixture is then heated under conditions in which pores generation reaction is initiated in the presence of activating agents. For example, the temperature can be maintained at about 150° C. for about 1 hour, and then raised to about 700° C. for between about 1 to about 4 hours. After cooling, the product is treated to quench any free metal that may have formed. For Example, the product can be soaked in a mixture of isopropanol (IPA) and water. The product is optionally filtered and washed with 4% hydrochloric acid and then DI water until the pH is neutral. The product is then optionally dried. For example, the product can be dried at 100° C.

The carbon source used to prepare the porous carbon can be selected from asphaltenes, such as heavy fractions of oil, coal, coke, charcoal, biochar, biomass, and combinations thereof. In some embodiments, the carbon source comprises gilsonite. In some embodiments, the porous carbon is prepared from a mixture of carbon sources.

In some embodiments, the carbon source used to prepare the porous carbon includes, without limitation, asphalt, asphaltenes, bituminous coal, charcoal, coke, activated carbon, biochar, biomass, and combinations thereof.

In some embodiments, the carbon source is asphaltenes, i.e. the heavy fraction of oil. In some embodiments, the carbon source is bituminous coal. In some embodiments, the carbon source is biochar.

In some embodiments the porous carbon is made by baking the carbon source with potassium hydroxide.

In some embodiments the FPC is made from the porous carbon by oxidation with strong oxidants in the media of concentrated strong acids.

The porous carbon can be obtained from the carbon source using any of a number of conventional methods.

In some embodiments, the porous carbon has a three-dimensional structure. In some embodiments, the porous carbon is in the form of particles. In some embodiments, the porous carbon comprises a plurality of pores.

Various oxidants may be utilized to prepare FPC. In some embodiments, the oxidant includes one or more compounds that are capable of oxidizing a porous carbon source, either individually or in combination. In some embodiments, the oxidant is in the form of a liquid medium. In some embodiments, the oxidant includes an anion. In some embodiments, the oxidant includes, without limitation, permanganates, chlorates, perchlorates, chromates, dichromates, nitrates, nitric acid, chlorosulfonic acid, sulfuric acid with dissolved sulfur trioxide, and combinations thereof. In more specific embodiments, the oxidant includes, without limitation, potassium permanganate, potassium chlorate, nitric acid, and combinations thereof.

In more specific embodiments, the oxidant includes a compound that is dissolved in an acid. In some embodiments, the compound includes, without limitation, permanganates, chlorates, perchlorates, hypochlorites, chromates, dichromates, nitrates, nitric acid, peroxides, and combinations of thereof. In some embodiments, the acid includes, without limitation, sulfuric acid, nitric acid, oleum, chorosulfonic acid, sulfuric acid with dissolved sulfur trioxide, and combinations thereof.

In more specific embodiments, the compound includes at least one of potassium permanganate, potassium chlorate, nitric acid, and combinations thereof. In additional embodiments, the compound is dissolved in sulfuric acid.

In further embodiments, the oxidant is potassium permanganate dissolved in sulfuric acid (also referred to as KMnO₄/H₂SO₄). In some embodiments, the oxidant is nitric acid dissolved in sulfuric acid (also referred to as HNO₃/H₂SO₄). In some embodiments, the oxidant is potassium dichromate dissolved in sulfuric acid (also referred to as K₂Cr₂O₇/H₂SO₄).

In some embodiments the acidic media is concentrated sulfuric acid, phosphoric acid, nitric acid, perchloric acid, and combinations of thereof In more specific embodiments, the acid media is concentrated sulfuric acid.

Various methods may be utilized to oxidize carbon sources to form FPC. In some embodiments, the oxidizing occurs by exposing the carbon source to an oxidant. In some embodiments, the exposing includes stirring the carbon source in a solution that contains the oxidant. Additional methods of exposing carbon sources to oxidants can also be envisioned.

In some embodiments, the functionalized porous carbon has a three-dimensional structure. In some embodiments, the functionalized porous carbon is in the form of particles. In some embodiments, the functionalized porous carbon comprises a plurality of pores.

In particular embodiments, the as-prepared porous carbon is subjected to oxidation by introducing the porous carbon into a mixture containing sulfuric acid (H₂SO₄) and KMnO₄. The reaction mixture is then optionally stirred for a time sufficient to allow the oxidation reaction to proceed toward completion. In some embodiments, the reaction mixture is stirred for about 3-4 hours. The reaction is then quenched. In some embodiments, the reaction is quenched with the addition of an ice-water mixture. Insoluble MnO₂ by-products are then converted to a soluble Mn(II) form. In some embodiments, the MnO₂ by-products are converted to a soluble Mn(II) form by the addition of H₂O₂. The reaction mixture is then optionally filtered to separate as-prepared FPC from diluted acidic waste. The FPC product from the filter cake is optionally washed (for example, with DI water several times) to remove sulfuric acid and inorganic by-products (such as K₂SO₄ and MnSO₄). The purification can be conducted until the washing waters filtrate has a neutral pH. The washed FPC is optionally dried. In some embodiments, the FPC is dried in open air. In other embodiments, the FPC product is dried under vacuum. In still other embodiments, the FPC is dried under ambient conditions.

In other particular embodiments, a mixture of nitric acid or potassium dichromate and sulfuric acid can be used for the oxidation of the porous carbon, instead of KMnO₄/H₂SO₄. Under this protocol, the porous carbon is dispersed in the acid mixture. In some embodiments, the sulfuric acid is concentrated sulfuric acid (96-98%). In some embodiments, the nitric acid is commercial concentrated (65-70%) nitric acid. The mixture is optionally stirred for a time sufficient to allow the oxidation reaction to proceed toward completion. In some embodiments, the reaction mixture is stirred for about 24 hours. The reaction mixture is then quenched. In some embodiments, the reaction mixture is quenched with an ice-water mixture. The diluted reaction mixture is optionally filtered to separate solid FPC product from diluted acids. The FPC is optionally washed (for example, with water several times) to remove sulfuric acid and nitric acid. It is expected that the formation and modification of surface functional groups will continue during the washing procedures due to the chemical interaction of oxidized carbon with water. The washed and as-modified FPC is optionally dried. In some embodiments, the FPC is dried in open air. In other embodiments, the FPC product is dried under vacuum. In still other embodiments, the FPC is dried under ambient conditions.

In some embodiments, the formed functionalized porous carbon material is separated from the oxidant. In some embodiments, the separation occurs by at least one of decanting, filtration, or centrifugation. In some embodiments, the separated sulfuric acid can be reused to prepare more functionalized porous carbons (i.e., recycled). In some embodiments, the reaction media and the oxidant can be recycled. In some embodiments, the separation of the functionalized porous carbon from the oxidant occurs by quenching the reaction with water, or with an ice-water mixture to speed up the separation of the oxidized carbon from the solution (e.g., sulfuric acid).

In some embodiments, the formed functionalized porous carbon material can also be dried. In some embodiments, the functionalized porous carbon material is dried under ambient conditions. In some embodiments, the functionalized porous carbon material can be dried at slightly elevated temperatures (60° C.) and reduced pressure in order to increase the product's sorption capacity.

The oxidation of porous carbon comprises exposing the porous carbon to an oxidizing mixture. The oxidizing mixture comprises an acid media and an oxidant dispersed in the acid media. The acid media includes, but is not limited to, sulfuric acid, nitric acid, perchloric acid, chlorosulfonic acid, phosphoric acid and combinations thereof. The oxidant includes, but is not limited to, permanganates, chlorates, perchlorates, chromates, dichromates, ferrates, nitrates, nitric acid, and combinations thereof. In more specific embodiments, the oxidant includes, but is not limited to, potassium permanganate, potassium chlorate, nitric acid, and combinations thereof

In some embodiments, the functionalized porous carbon is contacted by the fluid by dispersing the functionalized porous carbon in the fluid.

In some embodiments, the functionalized porous carbon is contacted by the fluid while the functionalized porous carbon is compartmentalized. In some embodiments, the functionalized porous carbon is compartmentalized in a porous container. In some embodiments the porous container has flexible walls, and can resemble a sack-like structure.

In some embodiments, the functionalized porous carbon is contacted by the fluid by flowing the fluid through a structure housing the functionalized porous carbon. In some embodiments, the structure is a column or a filter. In some embodiments, a cross-flow filtration system is used to capture contaminants from the fluid, where the functionalized porous carbon remains inside the cross-flow filtering system with captured contaminants (e.g., metals and radionuclides) while the treated fluid passes through the cross-flow filtering system.

In some embodiments, the sorption of contaminants from the fluid by the functionalized porous carbon comprises absorption of the contaminants inside the pores of the functionalized porous carbon. In some embodiments, the sorption of contaminants from the fluid by the functionalized porous carbon comprises adsorption of the contaminants to the walls of the pores of the functionalized porous carbon. The sorption effectiveness depends on the nature of the contaminants, on the absence or presence of competing ions, and on the amount of functionalized porous carbon used. In some embodiments, the sorption is at least about 99.9%, or at least about 85%, or at least about 70%, of the contaminants originally present in the fluid.

The methods of the present disclosure may be utilized to capture contaminants from various water sources. In some embodiments, the water sources may be contaminated with nuclear waste, such as nuclear fission products. In some embodiments, the water sources may include, without limitation, lakes, oceans, wells, ponds, rivers, water runoff, sea water, or mixtures thereof In some embodiments, the water sources include cooling water and washing water from nuclear reactors.

In some embodiments, the water sources can include, without limitation, fresh water, natural spring water, sea water, or combinations thereof

In some embodiments, the contents of water sources can affect the capture of contaminants from water sources. For instance, in some embodiments, the capture of heavier metals can be affected in the presence of much higher concentrations of lighter metals, such as sodium.

In some embodiments, the fluid is a water source.

The methods of the present disclosure may be utilized to capture various types of contaminants from water sources. In some embodiments, the contaminants include radionuclides, metals, and combinations thereof.

In some embodiments, the contaminants are selected from the group consisting of metal cations including radionuclides and heavy metals.

In some embodiments, the contaminants to be captured from water sources include radionuclides. In some embodiments, the radionuclides include, without limitation, uranium, thallium, americium, neptunium, gadolinium, bismuth, plutonium, barium, cadmium, europium, manganese, technetium, strontium, polonium, cesium, radium, actinides, lanthanides and combinations thereof. In more specific embodiments, the radionuclides to be captured from water sources include, without limitation, uranium, europium, cesium, strontium, and combinations thereof. In some embodiments, the radionuclides include, without limitation, strontium, cesium, uranium, actinium, europium and combinations thereof.

In some embodiments, the contaminants to be captured from water sources include metals. In some embodiments, the metals include, without limitation, heavy metals, light metals, metal cations, metal halides, metal sulfates, metal hydroxides, mixed metal cations, and combinations thereof

In some embodiments, the metals include light metals. In some embodiments, the light metals include, without limitation, magnesium, lithium, and combinations thereof

In some embodiments, the metals include heavy metals. In some embodiments, the heavy metals include, without limitation, mercury, plutonium, lead, vanadium, tungsten, cadmium, chromium, arsenic, nickel, tin, thallium, aluminum, beryllium, bismuth, thorium, uranium, osmium, gold and combinations thereof In some embodiments, the heavy metals include, without limitation, lead and mercury.

In some embodiments, the present disclosure pertains to methods of capturing contaminants from a water source. In some embodiments, the contaminants that are captured from the water source are radionuclides, metals, and combinations thereof. In some embodiments the methods of the present disclosure include a step of applying a functionalized porous carbon to the water source. This leads to the sorption of the contaminants in the water source by the FPC. In some embodiments, the methods of the present disclosure also include a step of separating the FPC from the water source.

As set forth in more detail herein, the methods of the present disclosure can apply various types of FPC to various water sources to remove contaminants from the water sources. In addition, various methods may be utilized to separate the functionalized porous carbons from the water sources after sorption of the contaminants.

Various amounts of functionalized porous carbon may be applied to water sources. For instance, in some embodiments, functionalized porous carbon may applied to water sources in amounts ranging from about 0.5 g to about 40 g per liter of water source.

Moreover, functionalized porous carbons may be applied to water sources in various states. In some embodiments, the functionalized porous carbon is applied to the water source in solid form. In some embodiments, the functionalized porous carbon is applied to the water source in liquid form (e.g., as a dispersion in a liquid). In some embodiments, the functionalized porous carbon is applied to the water source in solid and liquid forms.

Various methods may also be utilized to apply functionalized porous carbons to water sources. In some embodiments, the functionalized porous carbon is applied to the water source by dispersing the functionalized porous carbon in the water source. In some embodiments, the dispersing occurs by mixing or swirling the functionalized porous carbons in the water source for a certain amount of time (e.g., 10 minutes to 60 minutes). In some embodiments, the dispersing occurs by keeping the functionalized porous carbons in the water for a certain amount of time (e.g., 24 hours). In more specific embodiments, the functionalized porous carbon that is dispersed in the water source is in the form of solid particles with diameters that range from about 100 μm to about 3 mm. Additional methods of dispersing functionalized porous carbons in water sources can also be envisioned.

In some embodiments, the functionalized porous carbon is applied to the water source by flowing the water source through a structure housing the functionalized porous carbon. In some embodiments, the water source is repeatedly flowed through a structure housing the functionalized porous carbon so as to remove more of the contaminants from the water source with each pass.

In some embodiments, the structure is a column. In some embodiments, the structure is a cartridge. In more specific embodiments, a solid form of functionalized porous carbon can be used as an absorbing filler (e.g., individually or in combination with other components) in a sorption column to remove contaminants from a water source that flows through the column. In further embodiments, the functionalized porous carbon that is loaded onto a column is in the form of solid particles with diameters that range from about 100 μm to about 5 mm.

In some embodiments, a cross-flow (also referred to as a tangential flow) filtering system is used to capture contaminants from a water source. In some embodiments, functionalized porous carbon remains inside a cross-flow filtering system with captured contaminants (e.g., metals and radionuclides) while the purified water passes through the cross-flow filtering system.

In additional embodiments, the structure housing the functionalized porous carbon is a filter. In more specific embodiments, the filter is a cross-flow filter or a tangential flow filtering system. In some embodiments, contaminants are removed from a water source by flowing the water source through the filter containing the functionalized porous carbon.

In some embodiments, the functionalized porous carbon is applied to the water source while the functionalized porous carbon is compartmentalized. In more specific embodiments, the functionalized porous carbon is applied to the water source while the functionalized porous carbon is compartmentalized in a porous container. In some embodiments, the porous container may be composed of porous polymers (e.g., natural and synthetic polymers), filter paper, silk, plastics, nylons, ceramics, porous steel, and combinations thereof In some embodiments, the porous containers may contain porous hydrophilic plastics. In some embodiments, the porous containers may be in the form of a porous bag that resembles a tea bag or sock-like structure. In some embodiments the porous containers are made from regenerated cellulose, cellulose esters, polyethersulfone (PES), etched polycarbonate, collagen, and combinations thereof.

Contaminants may be captured by functionalized porous carbons in various manners. For instance, in some embodiments, contaminants may be captured by functionalized porous carbons through sorption. In some embodiments, the sorption includes absorption of the contaminants to the functionalized porous carbon. In some embodiments, the sorption includes adsorption of the contaminants to the functionalized porous carbon. In some embodiments, the sorption includes adsorption and absorption of the contaminants to the functionalized porous carbon. In some embodiments, the sorption includes an ionic interaction between the contaminants and the functionalized porous carbon.

Various amounts of contaminants may be captured by functionalized porous carbons. For instance, in some embodiments, the sorption of contaminants by the functionalized porous carbons results in the capture of at least about 50% of the contaminants in the water source. In some embodiments, the sorption of contaminants by the functionalized porous carbons results in the capture of at least about 60% of the contaminants in the water source. In some embodiments, the sorption of contaminants by the functionalized porous carbons results in the capture of at least about 75% of the contaminants in the water source. In some embodiments, the sorption of contaminants by the functionalized porous carbons results in the capture of at least about 80% of the contaminants in the water source. In some embodiments, the sorption of contaminants by the functionalized porous carbons results in the capture of at least about 85% of the contaminants in the water source. In some embodiments, the sorption of contaminants by the functionalized porous carbons results in the capture of at least about 90% of the contaminants in the water source. In some embodiments, the sorption of contaminants by the functionalized porous carbons results in the capture of at least about 99% of the contaminants in the water source. In some embodiments, the percentage of the captured contaminants in the water source represents the weight percentage of the total amount of radionuclides and metals in the water source.

In some embodiments, the methods of the present disclosure also include a step of separating the functionalized porous carbon from the water source. In some embodiments, the separating occurs after the applying step. In some embodiments, the separating occurs after sorption of the contaminants in the water source by the functionalized porous carbon.

Various methods may be utilized to separate functionalized porous carbon from water sources. In some embodiments, the separating occurs by decanting, centrifugation, ultra-centrifugation, filtration, ultra-filtration, precipitation, electrophoresis, reverse osmosis, sedimentation, incubation, treatment of the water source with acids, treatment of the water source with bases, treatment of the water source with coagulants and chelating agents, and combinations thereof. In more specific embodiments, separation occurs by decanting, filtration, or centrifugation.

In some embodiments, the separating step includes addition of a coagulant or a polymer to the water source. In some embodiments, the coagulant or polymer addition leads to a precipitation of the functionalized porous carbons from the water source. Thereafter, a step of decanting, filtration or centrifugation can separate the water source from the precipitated functionalized porous carbon.

Applicants have shown that functionalized porous carbons can be used to capture various contaminants from water sources. Furthermore, in some embodiments, the three-dimensional and granular structure of the functionalized porous carbons of the present disclosure eliminates any requirement of additional structural support. Moreover, the functionalized porous carbons of the present disclosure can be used in traditional absorption columns, or be dispersed and collected from water sources. In the latter case, functionalized porous carbons can be easily separated from water by self-sedimentation within a short period of time and following decanting.

Moreover, the contaminants captured by the functionalized porous carbons of the present disclosure can be managed in an efficient manner. For instance, upon capture, the carbon materials can be burned or incinerated to leave contaminants (e.g., metal ions or metal oxides) in a condensed state. In particular, the functionalized porous carbons can be converted to CO₂, CO and H₂O upon incineration. In such instances, the remaining contaminants (e.g., metal ions or metal oxides) may be in the form of ashes or condensed materials that could be readily recycled, condensed, or buried.

Accordingly, the methods and compositions of the present disclosure can have various applications. For instance, in some embodiments, the functionalized porous carbons can be used to effectively clean a water source from radionuclides and metals. In some embodiments, the functionalized porous carbons of the present disclosure can be used to extract metal cations (such as U) from ground waters.

Each of the documents referred to above are incorporated herein by reference in its entirety, for all purposes. The following specific examples will provide detailed illustrations of the methods of producing and utilizing compositions of the present invention. These examples are not intended, however, to limit or restrict the scope of the invention in any way and should not be construed as providing conditions, parameters or values which must be utilized exclusively in order to practice the present invention.

### EXAMPLES

Reference will now be made to more specific embodiments of the present disclosure and experimental results that provide support for such embodiments. However, Applicants note that the disclosure below is for illustrative purposes only and is not intended to limit the scope of the claimed subject matter in any way.

Preparation of Unfunctionalized PC from Raw Carbon Source:

First, the porous carbon is prepared from a raw carbon source. Untreated gilsonite was mixed with KOH in a blender or a roller. The weight ratio of KOH to untreated gilsonite was chosen from 4 to 2. The mixture was loaded into a tube furnace and purged under nitrogen atmosphere for 30 minutes. The temperature was then raised to 150° C. and this temperature was maintained for 1 hour. After 1 hour, the temperature was raised to 700° C. and this temperature was maintained at different chosen lengths of duration, which was between 1 to 4 hours at 700° C. After cooling, the product was soaked in a mixture of isopropanol (IPA) and water, thus quenching any free metal that may have formed. It was filtered and washed once with 4% hydrochloric acid and several washes with DI water until the pH was neutral, followed by drying at 100° C.

### Example 1

At a weight ratio of 2:1 (100 g of KOH: 50 g of untreated gilsonite), the precursor materials were uniformly mixed in a blender. The mixture contained in a quartz boat was loaded into a tube furnace and was purged under nitrogen atmosphere for 30 minutes. This temperature was then raised to 150° C. and this temperature was maintained for 1 hour for stabilization. After 1 hour, the temperature was further raised to 700° C. under nitrogen atmosphere and was maintained for 1 hour for carbonization. After cooling, the product was soaked in a mixture of isopropanol (IPA) and water, thus quenching any free metal that may have formed. It was filtered and washed once with 4% hydrochloric acid and several washes with DI water until the pH was neutral, followed by drying at 100° C. This example yielded porous carbon materials having BET surface area of 1632 m²/g with the yield of ˜40% (20 g).

### Example 2

At a weight ratio of 4:1 (41.6 of KOH: 10.4 g of untreated gilsonite), the precursor materials were uniformly mixed in a blender. The mixture contained in a quartz boat was loaded into a tube furnace and was purged under nitrogen atmosphere for 30 minutes. This temperature was then raised to 150° C. and this temperature was maintained for 1 hour for stabilization. After 1 hour, the temperature was further raised to 700° C. under nitrogen atmosphere and was maintained for 1 hour for carbonization. After cooling, the product was soaked in a mixture of isopropanol (IPA) and water, thus quenching any free metal that may have formed. It was filtered and washed once with 4% hydrochloric acid and several washes with DI water until the pH was neutral, followed by drying at 100° C. The porous carbon produced using this set of parameters has an increased BET of 1748 m²/g, but with a lowered yield of ˜21% (2.15 g).

### Example 3

At a weight ratio of 2:1 (100 g of KOH: 50 g of untreated gilsonite), the precursor materials were uniformly mixed in a blender. The mixture contained in a quartz boat was loaded into a tube furnace and was purged under nitrogen atmosphere for 30 minutes. This temperature was then raised to 150° C. and this temperature was maintained for 1 hour for stabilization. After 1 hour, the temperature was further raised to 700° C. under nitrogen atmosphere and was maintained for 4 hour for carbonization. After cooling, the product was soaked in a mixture of isopropanol (IPA) and water, thus quenching any free metal that may have formed. It was filtered and washed once with 4% hydrochloric acid and several washes with DI water until the pH was neutral, followed by drying at 100° C. This example yielded porous carbon materials having BET surface area of 1832 m²/g with the yield of ˜37% (18.65 g).

### Oxidation of Porous Carbon

### Example 4

Next, the as-prepared porous carbon was subjected to oxidation. 7 g of porous carbon (from Example 1) was introduced into a mixture containing 192 g sulfuric acid and 8.4 g KMnO4. Reaction mixture was stirred for 3-4 hours. In 3-4 hours, reaction was quenched with addition of 200 g of ice-water mixture. 2 mL of 30% H₂O₂ was added to convert insoluble MnO₂ by-products to soluble Mn (II) form. Reaction mixture was filtered to separate as-prepared FPC from diluted acidic waste.

The FPC product from the filter cake was washed with DI water several times to remove sulfuric acid and inorganic by-products (such as K₂SO₄ and MnSO₄). The purification was conducted until the washing waters filtrate has a neutral pH. The washed wet FPC was dried on open air. The above mentioned procedures yielded about 10 g of dry FPC.

### Example 5

Alternatively, a mixture of nitric acid and sulfuric acid can be used for the oxidation of coke instead of KMnO₄/H₂SO₄. Under this protocol, 7 g of porous carbon is dispersed in a mixture of 70 mL of concentrated sulfuric acid (96-98%) and 25 mL of commercial concentrated (65-70%) nitric acid. The mixture is stirred 24 hours. The reaction mixture is quenched with 200 mL of ice-water mixture. The diluted reaction mixture is filtered to separate solid FPC product from diluted acids. The FPC is washed with water several times to remove sulfuric acid and nitric acid. The formation and modification of surface functional groups continues during the washing procedures due to the chemical interaction of oxidized carbon with water. The washed and as-modified FPC is dried under ambient conditions.

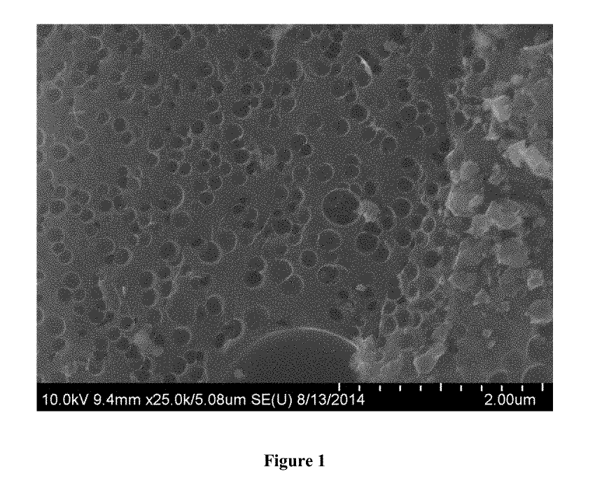

The SEM image in FIG. 1 shows that the particulate and porous structure of original porous carbon is preserved. This makes FPC very different from lamellar graphite oxide produced by oxidation of graphite. As produced graphite oxide, being exposed to water, completely exfoliates to single atomic layer graphene oxide sheets. The resulted graphene oxide (GO)-in-water colloid solution is very stable and resistive to separation by centrifugation. However, unlike two-dimensional graphene oxide, FPC retains its original three-dimensional granular structure. Therefore, FPC can be used in traditional sorption columns.

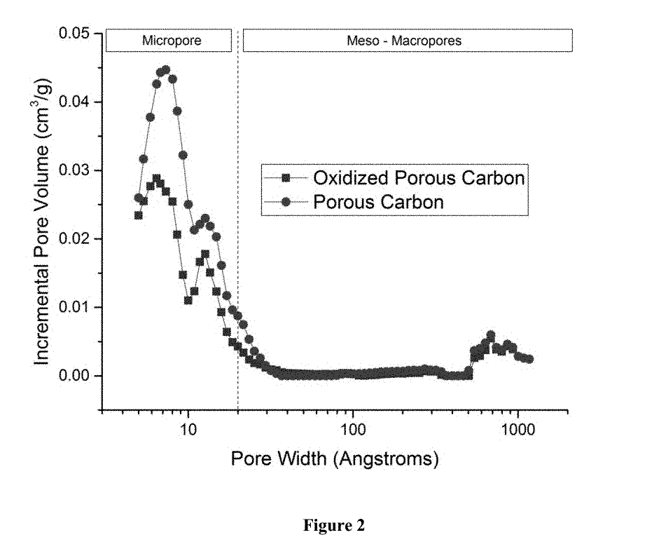

FIG. 2 provides the pore volume distribution for KMnO₄-FPC of Example 4 and the unfunctionalized porous carbon. The figure shows that the micropore structure of the porous carbon is preserved after oxidation, though it is slightly decreased.

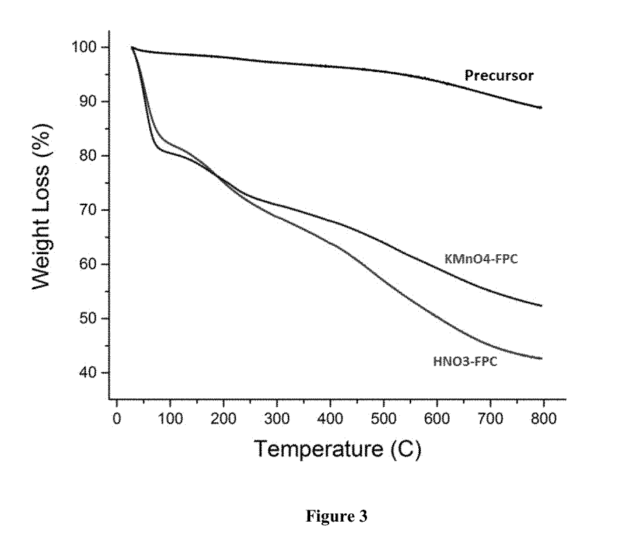

FIG. 3 provides thermogravimetric analysis (TGA) data of the FPC of Examples 4 and 5 in comparison to the porous carbon. The porous carbon does not lose any weight up to 600° C., and loses only a few percent at temperatures above 600° C. In contrast, the TGA curve for FPC is typical for the oxidized forms of carbon. FPC loses 3% of its weight as the temperature is raised between 22° C. and 70° C. Without being bound by theory, such weight loss is believed to be associated with adsorbed water. More significant weight loss of FPC occurs as the temperature is raised between 170° C. and 230° C. Without being bound by theory, such weight loss is believed to be associated with decomposition of the surface oxygen functional groups. The data indicates a high oxidation level of FPC compared to porous carbon.

### Sorption Studies

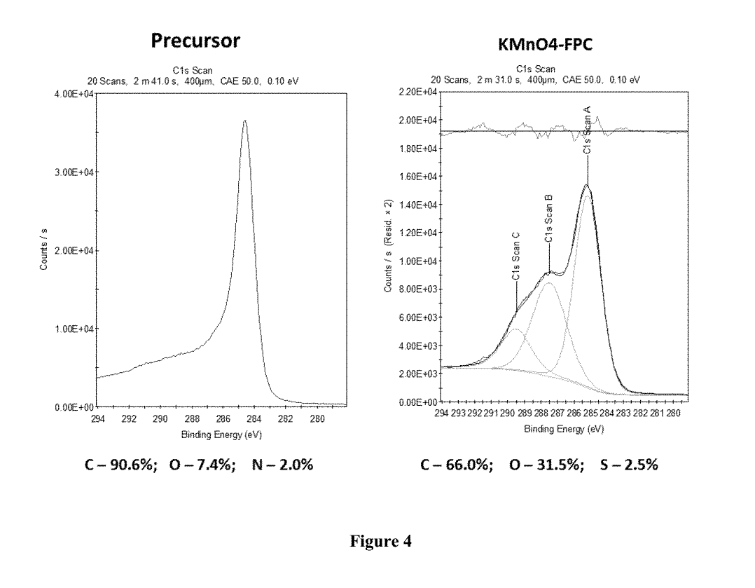

FIG. 4 shows the C1s XPS spectra for the FPC of Example 4 in comparison to that for the porous carbon. The peak at 284.8 eV corresponds to elemental carbon. The peak at 288 eV corresponds to the carbon atoms covalently bonded to oxygen with formation of several functionalities. The intense 288 eV peak suggests that the FPC surface is heavily functionalized with oxygen. Thus, the surface of FPC is very different from the surface of original coke. In addition to the appearance of the 288 eV peak, the 284.8 eV peak broadens. This observation indicates that there is a significant change of the coke surface upon oxidation.

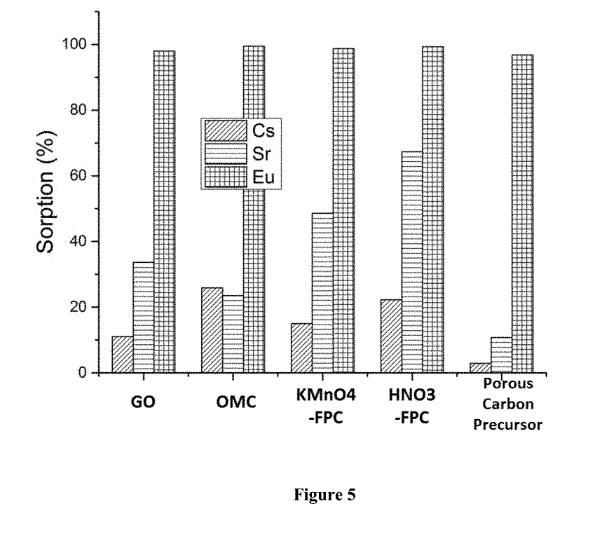

FIG. 5 provides comparative data for sorption of the FPC of Examples 4 and 5, and the unoxidized porous carbon. The sorption of the two FPC samples (KMnO₄-FPC and HNO₃-FPC) is compared to that of the unoxidized porous carbon, GO and OMC. 500 mg sorbent introduced into 1.0 L of “contaminated” water and agitated; Regular fresh water is used to model “contaminated” water; original concentrations of Cs, Sr, and Eu in “contaminated” water are 1.0 E-6 M each; the sorption (exposure) time is 2 h. The data show that at the given loading (500 mg sorbent per 1.0 L of water) FPC outperforms GO both in Cs and Sr. It underperforms OMC with respect to Cs, however outperforms it in sorption of Sr. Finally, FPC outperforms the porous carbon precursor, due to the lack of oxygen functional groups on the latter.

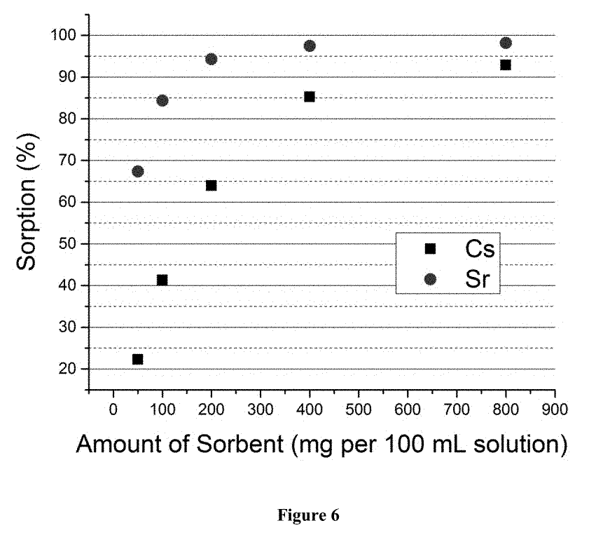

FIG. 6 is the sorption isotherm for the FPC of Example 5 (HNO₃-FPC). The experiment conditions are the same as for the experiment shown on the FIG. 4. Only 200 mg of HNO₃-FPC per 100 mL (2 g/L) of “contaminated” water removes ˜95% Sr. Only 800 mg HNO₃-FPC per 100 mL of contaminated water removes >90% Cs. The Cs sorption is selective: almost no K was absorbed, while Cs sorption is almost quantitative.

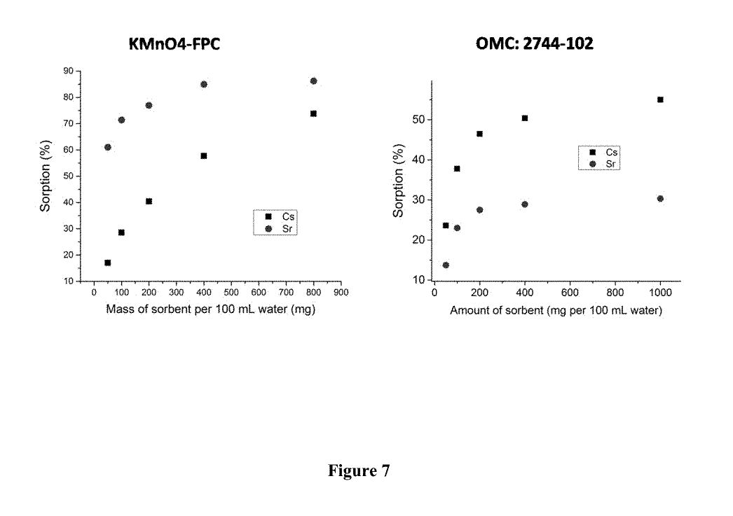

FIG. 7 is a comparison of the sorption effectiveness of KMnO₄-FPC (Example 4) with that for OMC. The data show that the FPC significantly outperforms the OMC reference sample at higher loadings; with only 4 g FPC per liter of fresh water, the sample removes 85% Sr and 57% Cs; there is no saturation with Cs (i.e., additional sorbent will remove more metal from water); and removal of Eu is approximately 99% at 50 mg/mL for both samples.

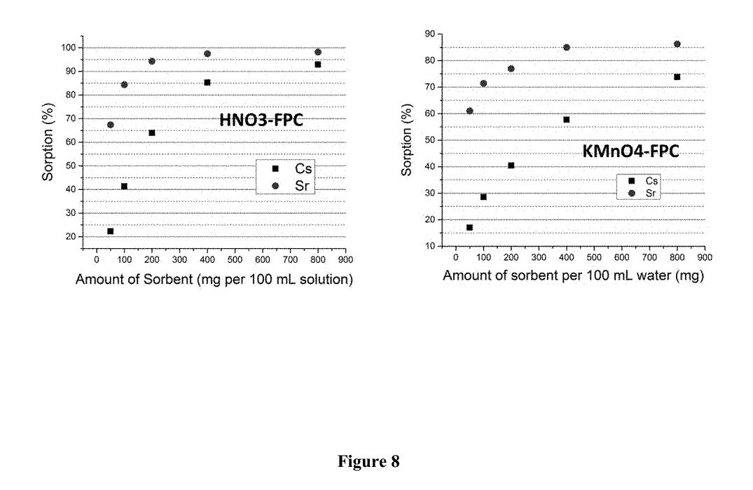

FIG. 8 is a comparison of the sorption effectiveness of HNO₃-FPC (Example 5) with that for KMnO₄-FPC (Example 4). The data show that only 200 mg FPC per 100 mL (2 g/L) of contaminated water removes approximately 94% Sr; and 800 mg FPC per 100 mL of contaminated water removes >90% Cs.

We claim:

1. A material comprising a functionalized porous carbon, wherein the functionalized porous carbon has an average surface area above 300 m²/g.

2. The material of claim 1, wherein the functionalized porous carbon has an average surface area ranging from 400 m²/g. to 4000 m²/g.

3. The material of claim 1, wherein the functionalized porous carbon has an average surface area ranging from 600 m²/g. to 3000 m²/g.

4. The material of claim 1, wherein the functionalized porous carbon has an average surface area ranging from 1600 m²/g. to 2000 m²/g.

5. The material of claim 1, wherein the functionalized porous carbon comprises oxygen-containing functional groups.

6. The material of claim 3, wherein the oxygen-containing functional groups comprises carboxylic groups.

7. A method of forming a functionalized porous carbon comprising the step of treating a porous carbon having an average surface area above 300 m²/g with an oxidizer.

8. The method of claim 7, further comprising the step of treating a carbon source with one or more etchants, activated agents and/or pore generating agents at high temperature to form the porous carbon.

9. The method of claim 7, further comprising the step of treating a carbon source with KOH, NaOH or LiOH at high temperature to form the porous carbon.

10. The method of claim 8, wherein the carbon source is obtained from a source comprising asphaltene, biochar, and combinations thereof

11. The method of claim 8, wherein the carbon source comprises asphaltene.

12. The method of claim 11, wherein the carbon source comprises asphalt.

13. The method of claim 8, wherein the carbon source comprises gilsonite.

14. The method of claim 7, wherein the oxidizer comprises a compound selected from the group consisting of KMnO₄, HNO₃, K₂Cr₂O₇ and combinations thereof.

15. A method of treating a fluid comprising a contaminant, the method comprising the step of contacting the fluid with a functionalized porous carbon under conditions that lead to sorption of the contaminant by the functionalized porous carbon.

16. The method of claim 15, wherein the contaminant comprises radionuclides, metals and combinations thereof.

17. The method of claim 16, wherein the radionuclides are selected from the group consisting of Sr, Cs, U, Ac, Eu and combinations thereof.

18. The method of claim 16, wherein the metals are selected from the group consisting of heavy metals, light metals, metal cations, metal halides, metal sulfates, metal hydroxides, mixed metal cations, and combinations thereof.

19. The method of claim 15, wherein the fluid is water.
